(19) United States
(12) Patent Application Publication
(10) Pub. No.: US 2007/0223885 A1
(43) Pub. Date: Sep. 27, 2007

(54) Playback apparatus

(76) Inventors: Shinji Kuno, Ome-shi (JP); Takanobu Mukaide, Tachikawa-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/724,562

(22) Filed: Mar. 15, 2007

(30) Foreign Application Priority Data
Mar. 22, 2006 (JP) 2006-078223

(51) Int. Cl. H04N 7/00

(52) U.S. Cl. 386/96

(57) ABSTRACT

According to one embodiment, a playback apparatus includes first to third digital signal processors. The first digital signal processor includes decode functions corresponding to a plurality of kinds of compression-decoding schemes and decodes first audio data, which is compression-encoded by using an arbitrary one of the plurality of kinds of compression-encoding schemes, thereby generating a first digital audio signal. The second digital signal processor includes decode functions corresponding to the plurality of kinds of compression-decoding schemes and decodes second audio data, which is compression-encoded by using an arbitrary one of the plurality of kinds of compression-encoding schemes, thereby generating a second digital audio signal. The third digital signal processor executes a mixing process of mixing the first digital audio signal and the second digital audio signal, thereby generating a digital audio output signal.

### CROSS-REFERENCE TO RELATED APPLICATIONS

This application is based upon and claims the benefit of priority from Japanese Patent Application No. 2006-078223, filed Mar. 22, 2006, the entire contents of which are incorporated herein by reference.

### BACKGROUND

1. Field

One embodiment of the invention relates to a playback apparatus such as a High-Definition Digital Versatile Disc (HD DVD) player.

2. Description of the Related Art

In recent years, with the development in digital compression-encoding technology of motion video, playback apparatuses (players) capable of handling high-definition video according to the High-Definition (HD) standard have been continuously developed.

In this type of player, there has been a demand for blending a plurality of image data at a high level in order to enhance interactivity. As a technique for overlaying image data, there is known an alpha blending technique. The alpha blending technique is a blending technique in which alpha data which is indicative of the degree of transparency of each pixel of an image is used and thereby this image is overlaid on another image.

Jpn. Pat. Appln. KOKAI Publication No. 8-205092 discloses a system in which graphic data and video data are combined by a display controller. In this system, the display controller captures video data and overlays the captured video data on a partial area of a graphics screen.

In the player for playing back content such as an HD DVD title, it is also required to handle not only a plurality of image data but also a plurality of audio data which correspond to the image data.

In order to play back the content, such as a High-Definition Digital Versatile Disc (HD DVD) title, which includes a plurality of image data and a plurality of audio data, it is necessary to execute, in parallel with a process for generating a video signal, which forms a display screen image, from the plural image data, a process of generating an audio output signal by mixing the plural audio data.

However, in the player for playing back the content such as the HD DVD title, the plural audio data are compression-encoded. Thus, in order to generate an audio output signal from plural audio data, it is necessary to execute a process of decoding a plurality of compression-encoded audio data, and a process of mixing the plural decoded audio data. Accordingly, a very high arithmetic performance is required for generating the audio output signal.

Under the circumstances, it is necessary to realize a novel system structure which can efficiently process a plurality of audio data.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing an example of the structure of a playback apparatus according to an embodiment of the invention;

FIG. 2 is an exemplary diagram showing an example of the structure of a player application which is used in the playback apparatus shown in FIG. 1;

FIG. 3 is an exemplary diagram for describing an example of the functional structure of a software decoder which is realized by the player application shown in FIG. 2;

FIG. 4 is an exemplary view for explaining examples of kinds of audio CODECs, which are supported by the playback apparatus shown in FIG. 1;

FIG. 5 is an exemplary bock diagram showing an example of the structure of an audio process system which is provided in the playback apparatus shown in FIG. 1;

FIG. 6 is an exemplary diagram for explaining an example of connection between four DSPs which are provided in the audio process system shown in FIG. 5; and

FIG. 7 is an exemplary view showing an example of a mixing process operation which is executed by the audio process system shown in FIG. 5.

### DETAILED DESCRIPTION

Various embodiments according to the invention will be described hereinafter with reference to the accompanying drawings. In general, according to one embodiment of the invention, a playback apparatus includes first to third digital signal processors. The first digital signal processor includes decode functions corresponding to a plurality of kinds of compression-decoding schemes and decodes first audio data, which is compression-encoded by using an arbitrary one of the plurality of kinds of compression-encoding schemes, thereby generating a first digital audio signal. The second digital signal processor includes decode functions corresponding to the plurality of kinds of compression-decoding schemes and decodes second audio data, which is compression-encoded by using an arbitrary one of the plurality of kinds of compression-encoding schemes, thereby generating a second digital audio signal. The third digital signal processor executes a mixing process of mixing the first digital audio signal which is output from the first digital signal processor and the second digital audio signal which is output from the second digital signal processor, thereby generating a digital audio output signal.

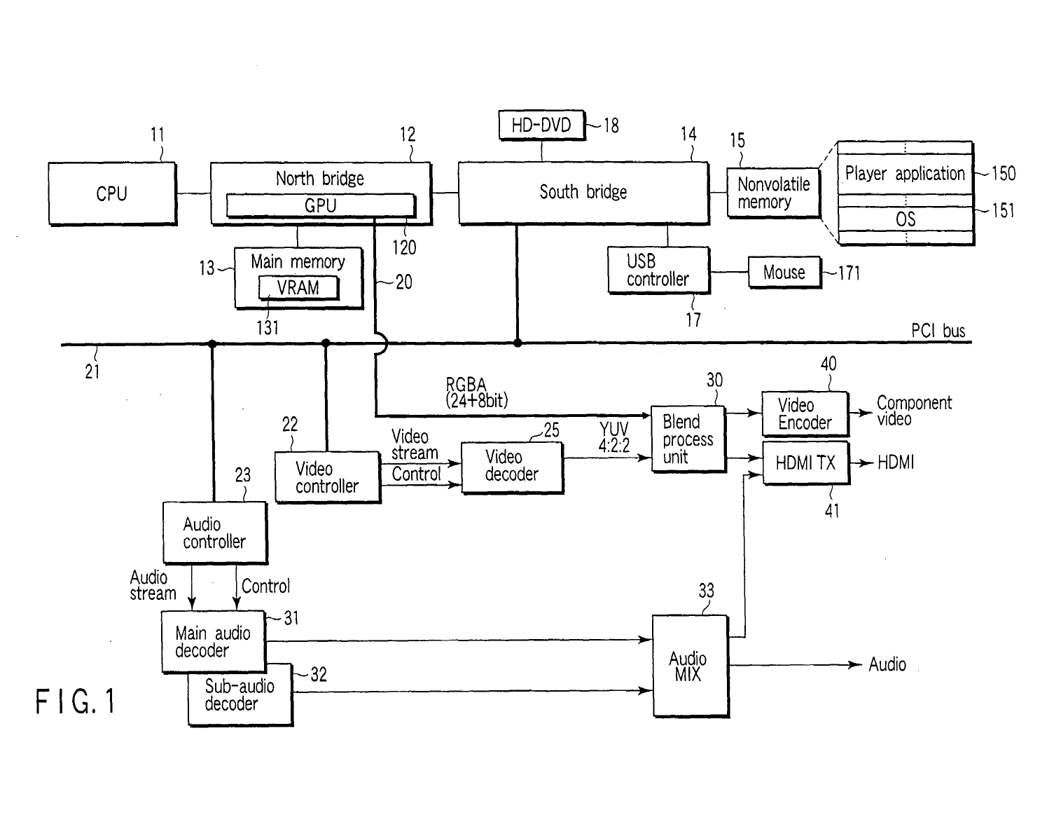

FIG. 1 shows an example of the structure of a playback apparatus according to an embodiment of the present invention. The playback apparatus is a media player which plays back audiovisual (AV) content. The playback apparatus is realized as an HD DVD player that plays back AV content, which is stored on DVD media according to, e.g., the High-Definition Digital Versatile Disc (HD DVD) standard.

As is shown in FIG. 1, the HD DVD player comprises a central processing unit (CPU) 11, a north bridge 12, a main memory 13, a south bridge 14, a nonvolatile memory 15, a Universal Serial Bus (USB) controller 17, an HD DVD drive 18, a graphics bus 20, a Peripheral Component Interconnect (PCI) bus 21, a video controller 22, an audio controller 23, a video decoder 25, a blend process unit 30, a main audio decoder 31, a sub-audio decoder 32, an audio mixer (Audio Mix) 33, a video encoder 40, and an AV interface (HDMI-TX) 41 such as a High-Definition Multimedia Interface (HDMI).

In this HD DVD player, a player application 150 and an operating system (OS) 151 are preinstalled in the nonvolatile memory 15. The player application 150 is software that runs on the OS 151, and executes a control to play back AV content that is read from the HD DVD drive 18.

AV content, which is stored in storage media, such as HD DVD media, which is driven by the HD-DVD drive 18, is composed of compression-encoded main video data, compression-encoded main audio data, compression-encoded sub-video data, compression-encoded sub-picture data, graphics data including alpha data, compression-encoded sub-audio data, and navigation data for controlling playback of the AV content.

The compression-encoded main video data is video data (primary screen image) corresponding to, e.g., a main title of a movie, and is composed of motion video data which is compression-encoded by a compression-encoding scheme of H.264/AVC standard. The main video data is composed of an HD standard high-definition image. Alternatively, main video data according to the Standard-Definition (SD) standard may be used. The compression-encoded main audio data is audio data corresponding to the main video data. The playback of the main audio data is executed in sync with playback of the main video data.

The compression-encoded sub-video data is video data (secondary screen image) which is displayed in the state in which it is overlaid on the image of the main video. The compression-encoded sub-video data is composed of a motion video image (e.g., a scene of an interview with a movie director) which supplements the main video data. The compression-encoded sub-audio data is audio data corresponding to the sub-video data. The playback of the sub-audio data is executed in sync with playback of the sub-video data.

The graphics data is a sub-screen image which is also displayed in a state in which it is overlaid on the main video. The graphics data is composed of various data (advanced elements) for displaying operation guidance such as a menu object. Each of the advanced elements is composed of a still image, motion video (including animation), text, etc. The player application 150 includes a drawing function for drawing a picture in accordance with a mouse device operation by a user. An image drawn by the drawing function is also used as graphics data and can be displayed in the state in which it is overlaid on the main video.

The compression-encoded sub-picture data is composed of text such as subtitles.

The navigation data includes a playlist for controlling a playback sequence of content, and a script for controlling playback of sub-video and graphics (advanced elements). The script is described in a markup language such as XML.

The HD standard main video has a resolution of, e.g., 1920×1080 pixels or 1280×720 pixels. Each of the sub-video data, sub-picture data and graphics data has a resolution of, e.g., 720×480 pixels.

In this HD DVD player, software (player application 150) executes, for example, a demultiplex process for demultiplexing a HD DVD stream, which is read from the HD DVD drive 18, into main video data, main audio data, sub-video data, sub-audio data, graphics data and sub-picture data, and a decoding process for decoding the sub-video data, sub-picture data and graphics data. On the other hand, hardware executes processes which require a great deal of processing, such as a decoding process for decoding main video data, and a decoding process for decoding main audio data and sub-audio data.

The CPU 11 is a processor which is provided in order to control the operation of the HD DVD player. The CPU 11 executes the OS 151 and player application 150, which are loaded from the nonvolatile memory 15 into the main memory 13. A part of the memory area within the main memory 13 is used as a video memory (VRAM) 131. It is not necessary, however, to use a part of the memory area within the main memory 13 as the VRAM 131. The VRAM 131 may be provided as a memory device that is independent from the main memory 13.

The north bridge 12 is a bridge device that connects a local bus of the CPU 11 and the south bridge 14. The north bridge 12 includes a memory controller that access-controls the main memory 13. The north bridge 12 also includes a graphics processing unit (GPU) 120.

The GPU 120 is a graphics controller that generates a graphics signal, which forms a graphics screen image, from data that is written by the CPU 11 in the video memory (VRAM) 131. The GPU 120 generates a graphics signal by using a graphics arithmetic function such as bit block transfer. For example, in a case where image data (sub-video, sub-picture, graphics, cursor) are written in four planes in the VRAM 131 by the CPU 11, the GPU 120 executes a blending process, with use of bit block transfer, which blends the image data corresponding to the four planes on a pixel-by-pixel basis, thereby generating a graphics signal for forming a graphics screen image with the same resolution (e.g., 1920×1080 pixels) as the main video. The blending process is executed by using alpha data that are associated with the sub-video, sub-picture and graphics. The alpha data is a coefficient representative of the degree of transparency (or the degree of opacity) of each pixel of the image data associated with the alpha data. The alpha data corresponding to the sub-video, sub-picture and graphics are stored in the HD DVD media together with the image data of the sub-video, sub-picture and graphics. Specifically, each of the sub-video, sub-picture and graphics is composed of image data and alpha data.

The graphics signal that is generated by the GPU 120 has an RGB color space. Each pixel of the graphics signal is expressed by digital RGB data (24 bits).

The GPU 120 includes not only the function of generating the graphics signal that forms a graphics screen image, but also a function of outputting alpha data, which corresponds to the generated graphics signal, to the outside.

Specifically, the GPU 120 outputs the generated graphics signal to the outside as an RGB video signal, and outputs the alpha data, which corresponds to the generated graphics signal, to the outside. The alpha data is a coefficient (8 bits) representative of the transparency (or opacity) of each pixel of the generated graphics signal (RGB data). The GPU 120 outputs, on a pixel-by-pixel basis, graphics output data with alpha data (32-bit RGBA data), which comprise the graphics signal (24-bit digital RGB video signal) and alpha data (8-bit). The graphics output data with alpha data (32-bit RGBA data) is sent to the blend process unit 30 over the dedicated graphics bus 20. The graphics bus 20 is a transmission line that is connected between the GPU 120 and the blend process unit 30.

In this HD DVD player, the graphics output data with alpha data is directly sent from the GPU 120 to the blend process unit 30 via the graphics bus 20. Thus, there is no need to transfer the alpha data from the VRAM 131 to the blend process unit 30 via, e.g., the PCI bus 21, and it is possible to prevent an increase in traffic of the PCI bus 21 due to the transfer of alpha data.

If the alpha data is transferred from the VRAM 131 to the blend process unit 30 via, e.g., the PCI bus 21, it would be necessary to synchronize the graphic signal output from the GPU 120 and the alpha data transferred via the PCI bus 21 within the blend process unit 30. This leads to complexity in structure of the blend process unit 30. In this HD DVD player, the GPU 120 outputs the graphics signal and alpha data by synchronizing them on a pixel-by-pixel basis. Therefore, synchronization between the graphics signal and alpha data can easily be realized.

The south bridge 14 controls the devices on the PCI bus 21. The south bridge 14 includes an Integrated Drive Electronics (IDE) controller for controlling the HD-DVD drive 18. Further, the south bridge 14 has a function of controlling the nonvolatile memory 15 and USB controller 17. The USB controller 17 controls a mouse device 171. The user operates the mouse device 171, thus being able to execute menu section, etc. Needless to say, the mouse device 171 may be replaced with a remote-control unit, etc.

The HD DVD drive 18 is a drive unit for driving storage media such as HD DVD media that stores AV content according to the HD DVD standard.

The video controller 22 is connected to the PCI bus 21. The video controller 22 is an LSI for executing interface with the video decoder 25. A stream (Video Stream) of main video data, which is separated from the HD DVD stream by software, is sent to the video decoder 25 via the PCI bus 21 and video controller 22. In addition, decode control information (Control) that is output from the CPU 11 is sent to the video decoder 25 via the PCI bus 21 and video controller 22.

The video decoder 25 is a decoder that supports the H.264/AVC standard. The video decoder 25 decodes HD standard main video data and generates a digital YUV video signal that forms a video screen image with a resolution of, e.g., 1920×1080 pixels. The digital YUV video signal is sent to the blend process unit 30.

The blend process unit 30 is connected to the GPU 120 and video decoder 25, and executes a blending process of blending graphics output data, which is output from the GPU 120, and main video data, which is decoded by the video decoder 25. Specifically, this blending process is a blending process (alpha blending process) for blending, on a pixel-by-pixel basis, the digital RGB video signal, which forms the graphics data, and the digital YUV video signal, which forms the main video data, on the basis of the alpha data that is output along with the graphics data (RGB) from the GPU 120. In this case, the main video data is used as a lower-side screen image, and the graphics data is used as an upper-side screen image that is overlaid on the main video data.

The output image data that is obtained by the blending process is delivered, for example, as a digital YUV video signal, to the video encoder 40 and AV interface (HDMI-TX) 41. The video encoder 40 converts the output image data (digital YUV video signal), which is obtained by the blending process, to a component video signal or an S-video signal, and outputs it to an external display device (monitor) such as a TV receiver. The AV interface (HDMI-TX) 41 outputs digital signals including the digital YUV video signal and digital audio signal to an external HDMI device.

The audio controller 23 is connected to the PCI bus 21. The audio controller 23 is an LSI for executing interfaces with the main audio decoder 31 and sub-audio decoder 32. A stream of main audio data, which is separated from the HD DVD stream by software, is sent to the main audio decoder 31 via the PCI bus 21 and audio controller 23. A stream of sub-audio data, which is separated from the HD DVD stream by software, is sent to the sub-audio decoder 32 via the PCI bus 21 and audio controller 23. Decode control information (Control) which is output from the CPU 11 is also sent to the main audio decoder 31 and sub-audio decoder 32 via the audio controller 23.

The main audio decoder 31 decodes the main audio data and generates an Inter-IC Sound (I2S) format digital audio signal. This digital audio signal is sent to the audio mixer (Audio Mix) 33. The main audio data is compression-encoded by using an arbitrary one of a plurality of kinds of predetermined compression-encoding schemes (i.e. a plurality of kinds of audio CODECs). Thus, the main audio decoder 31 has decoding functions corresponding to the plural kinds of compression-encoding schemes. Specifically, the main audio decoder 31 decodes the main audio data, which is compression-encoded by using an arbitrary one of a plurality of kinds of compression-encoding schemes, thereby generating a digital audio signal. The main audio decoder 31 is informed of the kind of the compression-encoding scheme corresponding to the main audio data, for example, by the decode control information from the CPU 11.

The sub-audio decoder 32 decodes the sub-audio data and generates an I2S format digital audio signal. This digital audio signal is sent to the audio mixer (Audio Mix) 33. The sub-audio data is also compression-encoded by using an arbitrary one of the above-described plurality of kinds of predetermined compression-encoding schemes (i.e. a plurality of kinds of audio CODECs). Thus, the sub-audio decoder 32 has decoding functions corresponding to the plural kinds of compression-encoding schemes. Specifically, the sub-audio decoder 32 decodes the sub-audio data, which is compression-encoded by using an arbitrary one of a plurality of kinds of compression-encoding schemes, thereby generating a digital audio signal. The sub-audio decoder 32 is informed of the kind of the compression-encoding scheme corresponding to the sub-audio data, for example, by the decode control information from the CPU 11.

The audio mixer (Audio Mix) 33 executes a mixing process of mixing the main audio data, which is decoded by the main audio decoder 31, and the sub-audio data, which is decoded by the sub-audio decoder 32, thereby generating a digital audio output signal. The digital audio output signal is sent to the AV interface (HDMI-TX) 41, converted to an analog audio output signal, and output from the playback apparatus.

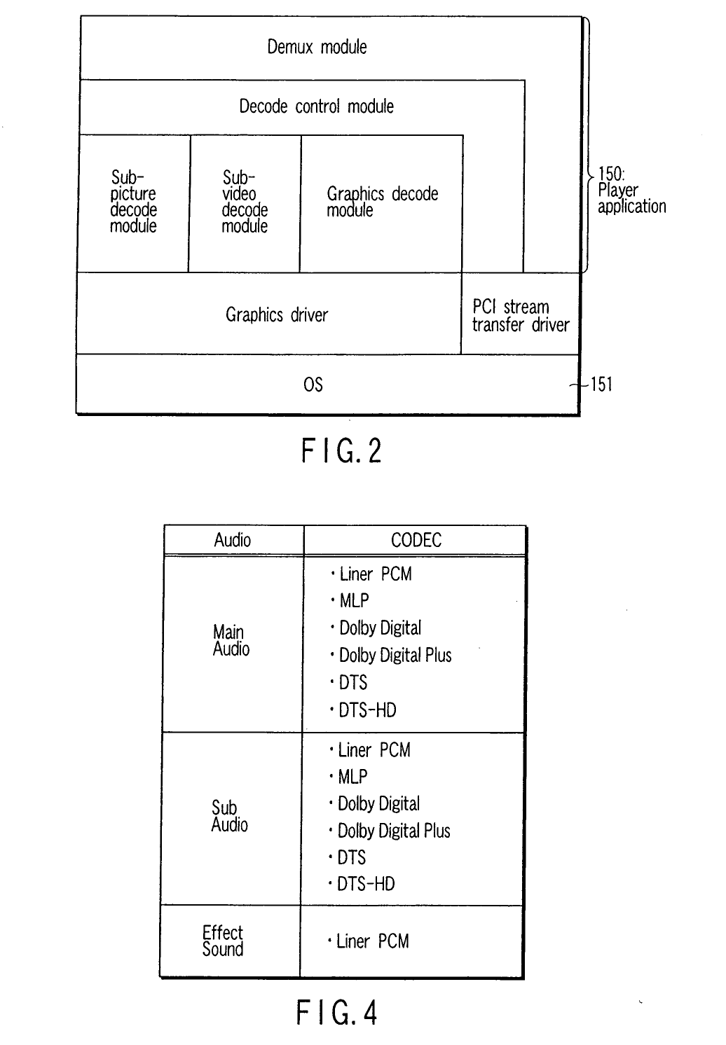

Next, referring to FIG. 2, the functional structure of the player application 150, which is executed by the CPU 11, is described.

The player application 150 comprises a demultiplex (Demux) module, a decode control module, a sub-picture (Sub-Picture) decode module, a sub-video (Sub-Video) decode module, and a graphics decode module.

The Demux module is software that executes a demultiplex process for separating, from the stream read from the HD DVD drive 18, main video data, main audio data, sub-picture data, sub-video data, and sub-audio data. The decode control module is software that controls decoding processes for the main video data, main audio data, sub-picture data, sub-video data, sub-audio data and graphics data, on the basis of navigation data.

The sub-picture (Sub-Picture) decode module decodes the sub-picture data. The sub-video (Sub-Video) decode module decodes the sub-video data. The graphics decode module decodes the graphics data (advanced elements).

A graphics driver is software for controlling the GPU 120. The decoded sub-picture data, decoded sub-video data and decoded graphics are sent to the GPU 120 via the graphics driver. The graphics driver issues various instructions for drawing to the GPU 120.

A PCI stream transfer driver is software for transferring the stream via the PCI bus 21. The main video data, main audio data and sub-audio data are transferred by the PCI stream transfer driver to the video decoder 25, main audio decoder 31 and sub-audio decoder 32 via the PCI bus 21.

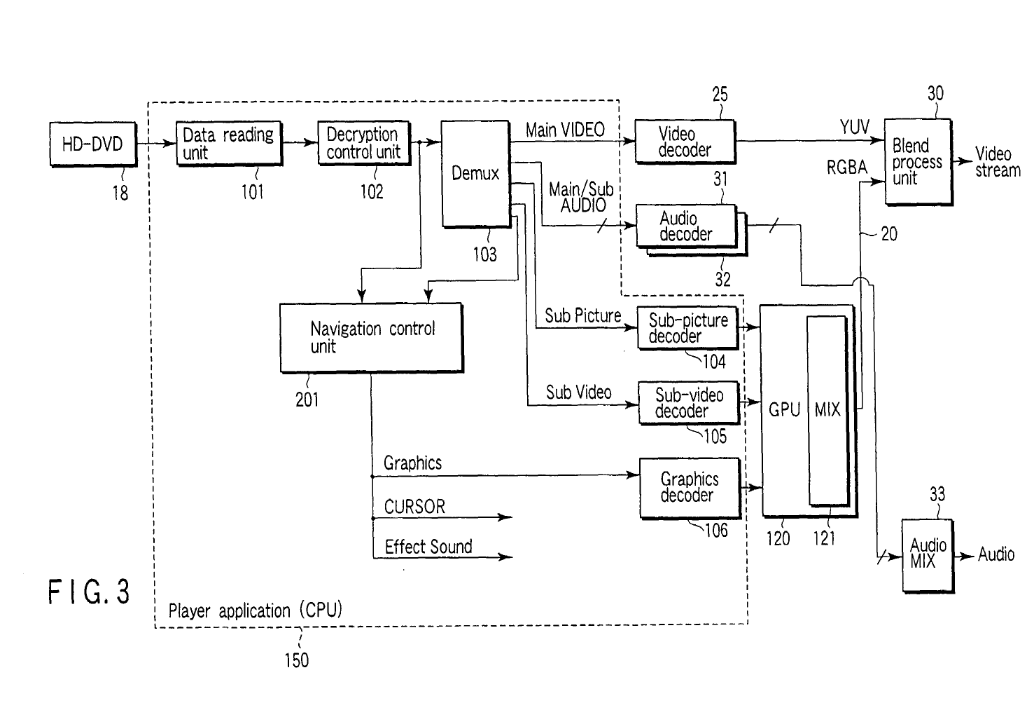

Next, referring to FIG. 3, a description is given of the functional structure of the software decoder that is realized by the player application 150, which is executed by the CPU 11.

The software decoder, as shown in FIG. 3, includes a data reading unit 101, a decryption process unit 102, a demultiplex (Demux) unit 103, a sub-picture decoder 104, a sub-video decoder 105, a graphics decoder 106 and a navigation control unit 201.

The content (main video data, sub-video data, sub-picture data, main audio data, sub-audio data, graphics data, navigation data) stored on the HD DVD media in the HD DVD drive 18 is read from the HD DVD drive 18 by the data reading unit 101. The main video data, sub-video data, sub-picture data, main audio data, sub-audio data, graphics data and navigation data are encrypted. The main video data, sub-video data, sub-picture data, main audio data and sub-audio data are multiplexed on the HD DVD stream. The main video data, sub-video data, sub-picture data, main audio data, sub-audio data, graphics data and navigation data, which are read from the HD DVD media by the data reading unit 101, are input to the decryption process unit 102. The decryption process unit 102 executes a process for decrypting the respective data. The decrypted navigation data is sent to the navigation control unit 201. The decrypted HD DVD stream is input to the demultiplex (Demux) unit 103.

The navigation control unit 201 analyzes the script (XML) included in the navigation data, and controls the playback of the graphics data (advanced elements). The graphics data (advanced elements) is sent to the graphics decoder 106. The graphics decoder 106 is composed of the graphics decode module of the player application 150, and decodes the graphics data (advanced elements).

The navigation control unit 201 executes a process for moving the cursor in accordance with the user's operation of the mouse device 171, and a process for playing back effect sound (Effect Sound) in response to menu selection.

The Demux 103 is realized by the Demux module in the player application 150. The Demux 103 separates, from the HD DVD stream, main video data, main audio data, sub-audio data, sub-picture data and sub-video data.

The main video data is sent to the video decoder 25 via the PCI bus 21. The main video data is decoded by the video decoder 25. The decoded main video data has a resolution of, e.g., 1920×1080 pixels according to the HD standard, and is sent to the blend process unit 30 as a digital YUV video signal.

The main audio data is sent to the main audio decoder 31 via the PCI bus 21. The main audio data is decoded by the main audio decoder 31. The decoded main audio data is sent to the audio mixer 33 as an I2S-format digital audio signal.

The sub-audio data is sent to the sub-audio decoder 32 via the PCI bus 21. The sub-audio data is decoded by the sub-audio decoder 32. The decoded sub-audio data is sent to the audio mixer 33 as an I2S-format digital audio signal.

The sub-picture data and sub-video data are sent to the sub-picture decoder 104 and sub-video decoder 105. The sub-picture decoder 104 and sub-video decoder 105 decode the sub-picture data and sub-video data, respectively. The sub-picture decoder 104 and sub-video decoder 105 are realized by the sub-picture decode module and sub-video decode module of the player application 150.

The sub-picture data, sub-video data and graphics data, which have been decoded by the sub-picture decoder 104, sub-video decoder 105 and graphics decoder 106, are written in the VRAM 131 by the CPU 11. Cursor data corresponding to a cursor image is also written in the VRAM 131 by the CPU 11. The sub-picture data, sub-video data, graphics data and cursor data include RGB data and alpha data (A) in association with each pixel.

The GPU 120 generates graphics output data for forming a graphics screen image of, e.g., 1920×1080 pixels, on the basis of the sub-video data, graphics data, sub-picture data and cursor data, which are written in the VRAM 131 by the CPU 11. In this case, the sub-video data, graphics data, sub-picture data and cursor data are blended by an alpha blending process that is executed by a mixer (MIX) unit 121 of the GPU 120.

In this alpha blending process, alpha data corresponding to the sub-video data, graphics data, sub-picture data and cursor data, which are written in the VRAM 131, are used. Specifically, each of the sub-video data, graphics data, sub-picture data and cursor data written in the VRAM 131 is composed of image data and alpha data. The mixer (MIX) unit 121 executes the blending process on the basis of the alpha data corresponding to the sub-video data, graphics data, sub-picture data and cursor data, and position information of each of the sub-video data, graphics data, sub-picture data and cursor data, which is designated by the CPU 11. Thereby, the mixer (MIX) unit 121 generates a graphics screen image in which the sub-video data, graphics data, sub-picture data and cursor data are overlaid on a background image of, e.g., 1920×1080 pixels.

The alpha value corresponding to each of the pixels in the background image is a value indicative of the transparency of each pixel, that is, zero. As regards the area where the image data are overlaid, new alpha data corresponding to this area is calculated by the mixer (MIX) unit 121.

In this way, the GPU 120 generates the graphics output data (RGB) that form the graphics screen image of 1920×1080 pixels, and the alpha data corresponding to the graphics data, on the basis of the sub-video data, graphics data, sub-picture data and cursor data. As regards a scene in which only one of the images of the sub-video data, graphics data, sub-picture data and cursor data is displayed, the GPU 120 generates graphics data that corresponds to a graphics screen image, in which only the displayed image (e.g., 720×480) is disposed on the background image of 1920×1080 pixels, and alpha data corresponding to the graphics data.

The graphics data (RGB) and alpha data, which are generated by the GPU 120, are sent as RGBA data to the blend process unit 30 via the graphics bus 20.

Next, the kinds of audio CODECs supported by the present HD DVD player are explained.

This HD DVD player supports five audio CODECs corresponding to the main audio data, namely, Meridian Lossless Pack (MLP), Dolby Digital, Dolby Digital Plus, Digital Theater System (DTS), and DTS-HD. Similarly, the HD DVD player supports five audio CODECs corresponding to the sub-audio data, namely, MLP, Dolby Digital, Dolby Digital Plus, DTS, and DTS-HD.

Content creators can use, as main audio data, digital audio data that is compression-encoded by an arbitrary CODEC selected from MLP, Dolby Digital, Dolby Digital Plus, DTS, and DTS-HD. Similarly, content creators can use, as sub-audio data, digital audio data that is compression-encoded by using an arbitrary CODEC selected from MLP, Dolby Digital, Dolby Digital Plus, DTS, and DTS-HD. Needless to say, digital audio data of, e.g., Liner PCM format is usable as the main audio data or sub-audio data.

The effect sound is composed of Liner PCM format digital audio data.

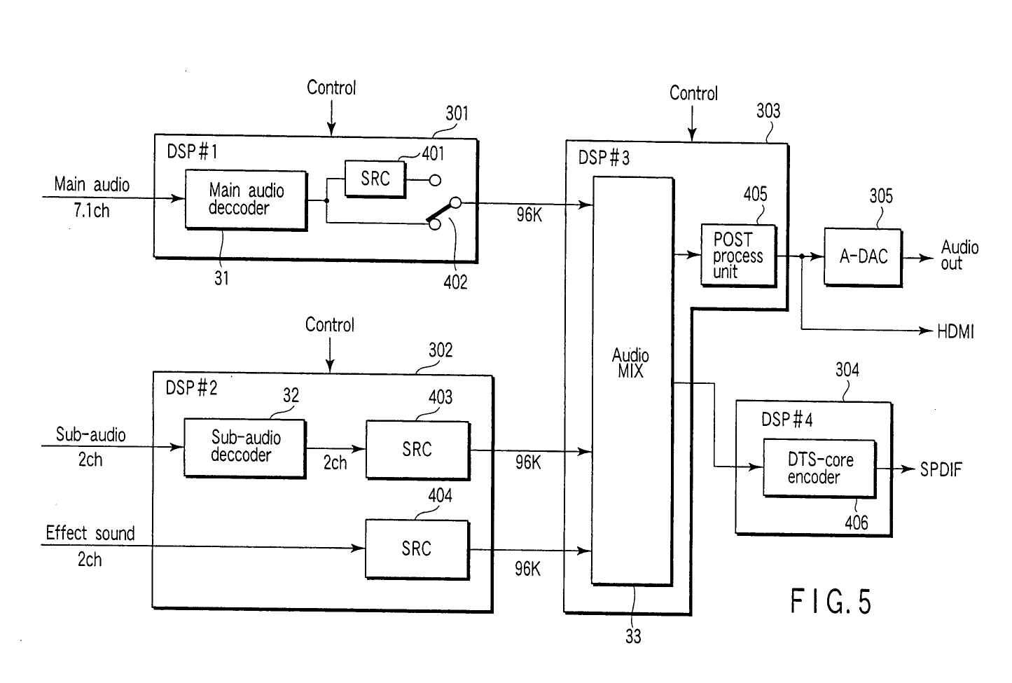

Next, referring to FIG. 5, a description is given of the structure of an audio process system for generating a digital audio output signal from the main audio data, sub-audio data and effect sound.

The present HD DVD player executes a dual decode triple mix process which decodes two compression-encoded digital audio data (main audio data and sub-audio data) and mixes three digital audio data including the two decoded digital audio data (main audio data and sub-audio data) and another digital audio data (effect sound).

In order to efficiently execute the dual decode triple mix process without newly developing a dedicated circuit, this audio process system is realized by using first to fourth digital signal processors 301, 302, 303 and 304.

The main audio decoder 31 is realized by a first digital signal processor (DSP#1) 301. The sub-audio decoder 32 is realized by a second digital signal processor (DSP#2) 302. The audio mixer (Audio Mix) 33 is realized by a third digital signal processor (DSP#3) 303. The fourth digital signal processor (DSP#4) 304 compression-encodes a digital audio output signal which is obtained by the audio mixer (Audio Mix) 33, and generates digital audio data which can be output from the playback apparatus via a predetermined audio output interface such as a Sony/Philips digital interface (SPDIF).

The first digital signal processor (DSP#1) 301 is so programmed as to decode, e.g., 7.1 channel main audio data. The first digital signal processor (DSP#1) 301 includes the main audio decoder 31, a sampling rate converter (SRC) 401 and a selector 402.

The main audio decoder 31 has decode functions corresponding to the above-described five kinds of CODECs, and decodes the main audio data by using the decode function corresponding to the kind of the CODEC of the main audio data, thereby generating a digital audio signal. The decode function to be used, that is, the kind of CODEC corresponding to the main audio data, is designated by decode control information (Control) which is supplied from the CPU 11 to the first digital signal processor (DSP#1) 301. Needless to say, in the case where the main audio data includes identification information that identifies the kind of CODEC corresponding to the main audio data, the main audio decoder 31 itself can determine the kind of CODEC corresponding to the main audio data.

The sampling rate of the main audio data, which is input to the main audio decoder 31, is, e.g., 48 or 96 kHz.

In the case where the sampling rate of the main audio data is 48 kHz, the SRC 401 up-converts the sampling rate of the main audio data from 48 to 96 kHz.

The selector 402 selects a digital audio signal which is output from the SRC 401, or a digital audio signal which is output from the main audio decoder 31. Specifically, if the sampling rate of the main audio data that is input to the main audio decoder 31 is 48 kHz, the selector 402 selects the digital audio signal that is output from the SRC 401. If the sampling rate of the main audio data that is input to the main audio decoder 31 is 96 kHz, the selector 402 selects the digital audio signal that is output from the main audio decoder 31. The value of the sampling rate of the main audio data is designated by the decode control information (Control) that is supplied from the CPU 11 to the first digital signal processor (DSP#1) 301.

Thereby, the first digital signal processor (DSP#1) 301 can always supply the digital audio signal with the sampling rate of 96 kHz to the third digital signal processor (DSP#3) 303, regardless of the sampling rate of the main audio data that is input to the first digital signal processor (DSP#1) 301.

The second digital signal processor (DSP#2) 302 is so programmed as to decode, e.g., two-channel sub-audio data. The second digital signal processor (DSP#2) 302 includes the sub-audio decoder 32 and two sampling rate converters (SRCs) 403 and 404.

The sub-audio decoder 32 has decode functions corresponding to the above-described five kinds of CODECs, and decodes the sub-audio data by using the decode function corresponding to the kind of the CODEC of the sub-audio data, thereby generating a digital audio signal. The decode function to be used, that is, the kind of CODEC corresponding to the sub-audio data, is designated by decode control information (Control) which is supplied from the CPU 11 to the second digital signal processor (DSP#2) 302. Needless to say, in the case where the sub-audio data includes identification information that identifies the kind of CODEC corresponding to the sub-audio data, the sub-audio decoder 32 itself can determine the kind of CODEC corresponding to the sub-audio data.

The sampling rate of the sub-audio data, which is input to the sub-audio decoder 32, is, e.g., 12, 24 or 48 kHz.

The SRC 403 up-converts the sampling rate of the sub-audio data from 12, 24 or 48 kHz to 96 kHz. Specifically, if the sampling rate of the sub-audio data is 12 kHz, the SRC 403 executes a process of up-converting the sampling rate of the sub-audio data to an 8-times higher sampling rate. If the sampling rate of the sub-audio data is 24 kHz, the SRC 403 executes a process of up-converting the sampling rate of the sub-audio data to a 4-times higher sampling rate. If the sampling rate of the sub-audio data is 48 kHz, the SRC 403 executes a process of up-converting the sampling rate of the sub-audio data to a 2-times higher sampling rate. The value of the sampling rate of the sub-audio data is designated by the decode control information (Control) that is supplied from the CPU 11 to the second digital signal processor (DSP#2) 302.

Thereby, the second digital signal processor (DSP#2) 302 can always supply the digital audio signal with the sampling rate of 96 kHz to the third digital signal processor (DSP#3) 303, regardless of the sampling rate of the sub-audio data that is input to the second digital signal processor (DSP#2) 302.

The second digital signal processor (DSP#2) 302 executes a process of converting the sampling rate of the effect sound by using the SRC 404. The sampling rate of the effect sound, which is input to the second digital signal processor (DSP#2) 302, is, e.g., 12, 24 or 48 kHz.

The SRC 404 up-converts the sampling rate of the effect sound from 12, 24 or 48 kHz to 96 kHz. Specifically, if the sampling rate of the effect sound is 12 kHz, the SRC 404 executes a process of up-converting the sampling rate of the effect sound to an 8-times higher sampling rate. If the sampling rate of the effect sound is 24 kHz, the SRC 404 executes a process of up-converting the sampling rate of the effect sound to a 4-times higher sampling rate. If the sampling rate of the effect sound is 48 kHz, the SRC 404 executes a process of up-converting the sampling rate of the effect sound to a 2-times higher sampling rate. The value of the sampling rate of the effect sound is designated by the decode control information (Control) that is supplied from the CPU 11 to the second digital signal processor (DSP#2) 302.

Thereby, the second digital signal processor (DSP#2) 302 can always supply the effect sound, as a digital audio signal with the sampling rate of 96 kHz, to the third digital signal processor (DSP#3) 303, regardless of the sampling rate of the effect sound that is input to the second digital signal processor (DSP#2) 302.

The third digital signal processor (DSP#3) 303 is so programmed as to execute a process of mixing the three audio data, i.e. the decoded main audio data, decoded sub-audio data and effect sound.

The third digital signal processor (DSP#3) 303 includes the audio mixer (Audio Mix) 33 and a POST process unit 405.

The audio mixer (Audio Mix) 33 is connected to an output of the first digital signal processor (DSP#1) 301 and two outputs of the second digital signal processor (DSP#2) 302. The audio mixer (Audio Mix) 33 generates a digital audio output signal by executing a mixing process of mixing three digital audio signals, that is, the digital audio output signal (decoded main audio data) that is output from the first digital signal processor (DSP#1) 301, the digital audio output signal (decoded sub-audio data) that is output from the second digital signal processor (DSP#2) 302, and the digital audio output signal (effect sound) that is output from the second digital signal processor (DSP#2) 302.

Since the sampling rates of these three digital audio signals are equal (96 kHz), a digital audio output signal (e.g., a 5.1 channel digital audio output signal) in which the three digital audio signals are mixed, can be generated simply by executing the mixing process with a sampling cycle (sampling cycle=1/96 k) corresponding to the sampling rate of 96 kHz.

The POST process unit 405 subjects the digital audio output signal, which is obtained by the audio mixer (Audio Mix) 33, to post-processes (volume control process, bass control process, delay control process, etc.). The post-processed digital audio output signal is output to an external HDMI device via the AV interface (HDMI-TX) 41, and is also converted to an analog audio signal by the audio analog-to-digital converter (A-DAC) 305 and output from the playback apparatus.

The digital audio output signal, which is obtained by the audio mixer (Audio Mix) 33, is also sent to the fourth digital signal process or (DSP#4) 304. The fourth digital signal process or (DSP#4) 304 includes an encoder 406. The encoder 406 compression-encodes the 5.1 channel digital audio output signal, which is obtained by the audio mixer (Audio Mix) 33, by a compression-encoding scheme such as DTS, and generates digital audio data corresponding to a predetermined audio output interface such as SPDIF. The fourth digital signal processor (DSP#4) 304 may be provided with a down-sampling unit for decreasing the sampling rate of the digital audio output signal to 48 kHz, and a down-mix unit for decreasing the number of channels of the digital audio output signal from 5.1 to two. Thereby, the down-sampled and down-mixed digital audio output signal may be compression-encoded by the encoder 406.

As has been described above, in the audio process system of the present embodiment, the two processes that require a great deal of arithmetic operations, that is, the decoding of main audio data and the decoding of sub-audio data, are executed by two physically different DSPs 301 and 302. Further, the process of mixing the decoded main audio data, the decoded sub-audio data and the effect sound is executed by the DSP 303 which is physically different from the two DSPs 301 and 302. It is thus possible to efficiently distribute loads on the three DSPs 301, 302 and 303, and to efficiently execute the above-described dual decode triple mix process.

Furthermore, since each of the DSPs 301, 302 and 303 is composed of a programmable general-purpose DSP, these DSPs can flexibly cope with variations in specifications relating to audio processing.

The process unit for the effect sound is needless in a player which does not support output of effect sound.

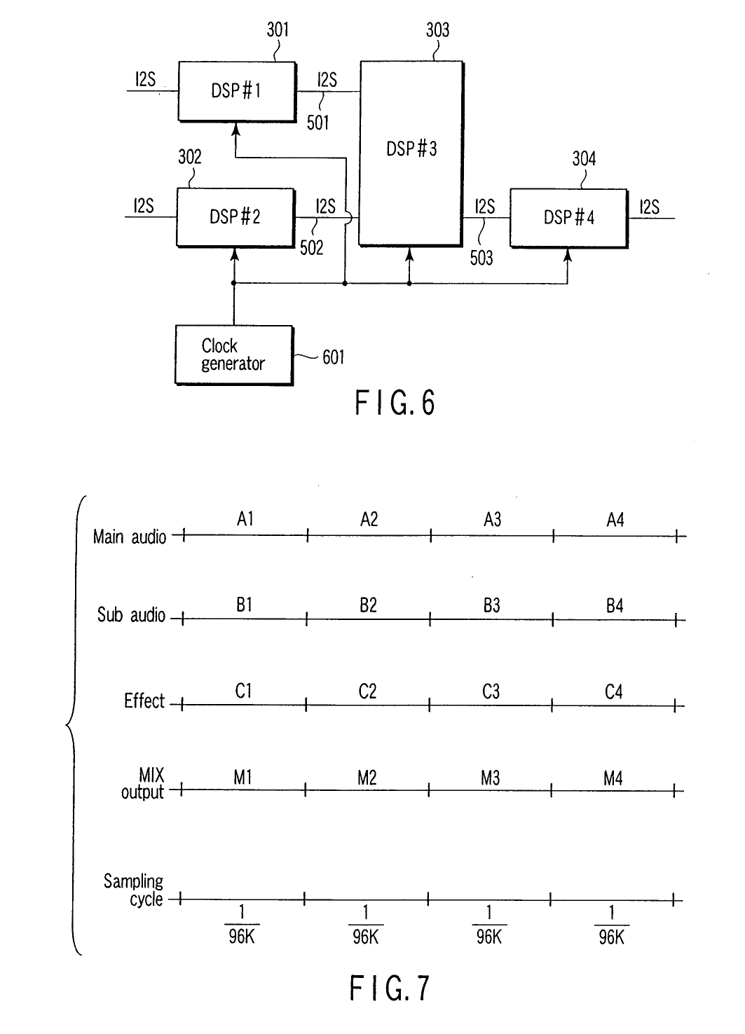

Next, the connection between the four DSPs 301, 302, 303 and 304 is described with reference to FIG. 6.

The first digital signal processor (DSP#1) 301 is connected to the third digital signal processor (DSP#3) 303 via an I2S bus 501. Specifically, the first digital signal processor (DSP#1) 301 sends the digital audio signal (decoded main audio data) to the third digital signal processor (DSP#3) 303 via the I2S bus 501 which connects the output of the first digital signal processor (DSP#1) 301 and the input of the third digital signal processor (DSP#3) 303.

The second digital signal processor (DSP#2) 302 is connected to the third digital signal processor (DSP#3) 303 via an I2S bus 502. Specifically, the second digital signal processor (DSP#2) 302 sends the digital audio signal (decoded sub-audio data) to the third digital signal processor (DSP#3) 303 via the I2S bus 502 which connects the output of the second digital signal processor (DSP#2) 302 and the input of the third digital signal processor (DSP#3) 303.

The third digital signal processor (DSP#3) 303 is connected to the fourth digital signal processor (DSP#4) 304 via an I2S bus 503. Specifically, the third digital signal processor (DSP#3) 303 sends the digital audio output signal, which is obtained by the mixing process, to the fourth digital signal processor (DSP#4) 304 via the I2S bus 503 which connects the output of the third digital signal processor (DSP#3) 303 and the input of the fourth digital signal processor (DSP#4) 304.

The I2S bus is a general-purpose audio bus which is supported as a mandatory bus by various audio control devices. By using the I2S buses for connecting the four DSPs 301, 302, 303 and 304, various alterations in system configuration in the future can flexibly be supported.

The four DSPs 301, 302, 303 and 304 are operated in sync with a clock signal from a clock generator 601.

Specifically, the DSP 301 sends the digital audio signal (decoded main audio data) to the DSP 303 in sync with the clock signal, and the DSP 302 sends the digital audio signal (decoded sub-audio data) and digital audio signal (effect sound) to the DSP 303 in sync with the clock signal. Thus, as shown in FIG. 7, the three digital audio signals (decoded main audio data, decoded sub-audio data and effect sound) having the same sampling rate are synchronously input to the DSP 303. Accordingly, the DSP 303 can precisely execute the mixing process.

In the mixing process, a process for calculating a digital audio output signal from the three digital audio signals (e.g., a process for calculating an averaged signal of the three digital audio signals) is executed in every 1 sampling cycle. For example, in the first sampling cycle, the DSP 303 calculates an average value M1 between main audio data A1, sub-audio data B1 and effect sound C1, and outputs the average value M1 as a digital audio output signal. In the second sampling cycle, the DSP 303 calculates an average value M2 between main audio data A2, sub-audio data B2 and effect sound C2, and outputs the average value M2 as a digital audio output signal. In the third sampling cycle, the DSP 303 calculates an average value M3 between main audio data A3, sub-audio data B3 and effect sound C3, and outputs the average value M3 as a digital audio output signal.

As described above, in the present embodiment, the three digital audio signals (decoded main audio data, decoded sub-audio data and effect sound) having the same sampling rate are synchronously input to the DSP 303. Thus, the digital audio output signal can easily be obtained by simply executing the mixing process in every sampling cycle.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A playback apparatus comprising:
a first digital signal processor which includes decode functions corresponding to a plurality of kinds of compression-decoding schemes and decodes first audio data, which is compression-encoded by using an arbitrary one of the plurality of kinds of compression-encoding schemes, thereby generating a first digital audio signal;
a second digital signal processor which includes decode functions corresponding to the plurality of kinds of compression-decoding schemes and decodes second audio data, which is compression-encoded by using an arbitrary one of the plurality of kinds of compression-encoding schemes, thereby generating a second digital audio signal; and
a third digital signal processor which executes a mixing process of mixing the first digital audio signal which is output from the first digital signal processor and the second digital audio signal which is output from the second digital signal processor, thereby generating a digital audio output signal.

2. The playback apparatus according to claim 1, wherein the first digital signal processor includes a first sampling rate conversion unit which up-converts, if a sampling rate of the first audio data is lower than a first sampling rate, the sampling rate of the decoded first audio data to the first sampling rate,
the second digital signal processor includes a second sampling rate conversion unit which up-converts a sampling rate of the decoded second audio data to the first sampling rate, and
the third digital signal processor executes the mixing process in every sampling cycle corresponding to the first sampling rate.

3. The playback apparatus according to claim 1, wherein the first digital signal processor sends the first digital audio signal to the third digital signal processor via a first I2S bus which connects the first digital signal processor and the third digital signal processor, and
the second digital signal processor sends the second digital audio signal to the third digital signal processor via a second I2S bus which connects the second digital signal processor and the third digital signal processor.

4. The playback apparatus according to claim 1, further comprising a fourth digital signal processor which compression-encodes the digital audio output, which is output from the third digital signal processor, and generates digital audio data corresponding to a predetermined audio output interface.

5. The playback apparatus according to claim 1, wherein the second digital signal processor includes a third sampling rate conversion unit which up-converts a sampling rate of a third audio data to the first sampling rate, thereby generating a third digital audio signal having the first sampling rate, and
the third digital signal processor executes a process of mixing the first digital audio signal, the second digital audio signal and the third digital audio signal in every sampling cycle corresponding to the first sampling rate.

6. A playback apparatus which plays back content that is stored in storage media and includes compression-encoded main video data, compression-encoded sub-video data, main audio data which is compression-encoded by using an arbitrary one of a plurality of kinds of compression-encoding schemes, and sub-audio data which is compression-encoded by using an arbitrary one of the plurality of kinds of compression-encoding schemes, the playback apparatus comprising:
means for reading the main video data, the sub-video data, the main audio data and the sub-audio data from the storage media;
means for decoding the read-out main video data;
means for decoding the read-out sub-video data;
a blend process unit which executes a blending process for overlaying the decoded main video data and the decoded sub-video data;
means for outputting image data, which is obtained by the blending process, to a display device;
a first digital signal processor which includes decode functions corresponding to the plurality of kinds of compression-decoding schemes and decodes the read-out main audio data, thereby generating a first digital audio signal;
a second digital signal processor which includes decode functions corresponding to the plurality of kinds of compression-decoding schemes and decodes the read-out sub-audio data, thereby generating a second digital audio signal;
a third digital signal processor which executes a mixing process of mixing the first digital audio signal which is output from the first digital signal processor and the second digital audio signal which is output from the second digital signal processor; and
means for outputting an audio signal which is obtained by the mixing process.

7. The playback apparatus according to claim 6, wherein the first digital signal processor includes a first sampling rate conversion unit which up-converts, if a sampling rate of the main audio data is lower than a first sampling rate, the sampling rate of the decoded main audio data to the first sampling rate,
the second digital signal processor includes a second sampling rate conversion unit which up-converts a sampling rate of the decoded sub-audio data to the first sampling rate, and
the third digital signal processor executes the mixing process in every sampling cycle corresponding to the first sampling rate.

8. The playback apparatus according to claim 6, wherein the first digital signal processor sends the first digital audio signal to the third digital signal processor via a first I2S bus which connects the first digital signal processor and the third digital signal processor, and
the second digital signal processor sends the second digital audio signal to the third digital signal processor via a second I2S bus which connects the second digital signal processor and the third digital signal processor.

9. The playback apparatus according to claim 6, further comprising a fourth digital signal processor which compression-encodes the digital audio output signal, which is output from the third digital signal processor, and generates digital audio data corresponding to a predetermined audio output interface.

10. The playback apparatus according to claim 6, wherein the second digital signal processor includes a third sampling rate conversion unit which up-converts a sampling rate of effect sound, which is read from the storage media, to the first sampling rate, thereby generating a third digital audio signal having the first sampling rate, and
the third digital signal processor executes a process of mixing the first digital audio signal, the second digital audio signal and the third digital audio signal in every sampling cycle corresponding to the first sampling rate.
